(19) United States
(12) Patent Application Publication
(10) Pub. No.: US 2013/0339084 A1
(43) Pub. Date: Dec. 19, 2013

(54) SYSTEM AND METHOD FOR OFFERING VETTED SERVICES OF AN ORIGINATOR/SUBJECT MATTER EXPERT

(71) Applicant: David B. Kahn, Princeton, NJ (US)

(72) Inventor: David B. Kahn, Princeton, NJ (US)

(21) Appl. No.: 13/856,098

(22) Filed: Apr. 3, 2013

Related U.S. Application Data
(60) Provisional application No. 61/622,070, filed on Apr. 10, 2012.
(60) Provisional application No. 61/717,510, filed on Oct. 23, 2012.

(51) Int. Cl. G06Q 30/02

(52) U.S. Cl. CPC G06Q 30/0201
USPC 705/7.29

(57) ABSTRACT

A system and method for offering vetted services of an originator/subject matter expert (O/SME) by a third party source of products and services of multiple O/SMEs may include storing data associated with the O/SME, the data inconclusive of product or service content representative of products or services being offered by the O/SME. Select data associated with the O/SME may be collected. An O/SME vetted data repository storing vetting data representative of vetting results of the O/SME may be queried. In response to receiving vetting data indicative of the O/SME having a vetting score above a passing vetting threshold value, an interactive booking feature may be displayed in relation to the select data associated with the O/SME and activated to enable a user to book services with the O/SME. Otherwise, the interactive booking feature may not be enabled to be displayed and activated.

### RELATED APPLICATIONS

This Application claims priority to co-pending U.S. Provisional Patent Applications 61/622,070 filed Apr. 10, 2012 and 61/717,510 filed Oct. 23, 2012; the contents of which are hereby incorporated by reference in their entirety.

### BACKGROUND OF THE INVENTION

### Online Reviews

There are many products and services offered through deal-of-the-day ecommerce venues and social purchasing groups at deep discounts, such as GroupOn® or Social Living®, along with services offered directly from other ecommerce sites. While these types of offerings are evaluated to some degree, consumers are left to their own research if the service provider actually offers a high quality service. Researching and purchasing services online presents a major obstacle: consumers do not know the true quality of a prospective purchase or whether the service provider is ethical, can be trusted, or is truly a subject matter expert. “Quality” is often measured by opinion, and, as understood in the art, online reviews can be easily manipulated by a service provider.

Certain rating services or peer-to-peer online services, such as Angie's List®, have made identification of quality service providers easier, but determining quality of such service providers are limited to what consumers think by way of online comments, and, online comments are not controlled by the peer-to-peer online services. For example, the service provider may directly submit positively biased reviews, friends of the service provider may submit positively biased reviews, or a competitor or adversary, such as an ex-partner or ex-employee, may submit negatively biased reviews. In some cases, a service provider may be considered an originator/subject matter expert (O/SME) if the service provider has originated a work (e.g., book, video, sculpture, music, etc.) and/or if the service provider qualifies as an expert in his or her respective field. This problem of opinion spamming or deceptive positive reviews is increasingly prevalent and, correspondingly, problematic. In other forums, such as social media, “likes,” endorsements, and “dislikes” (or any other terminology used to show approval and disapproval of an O/SME), present similar biased and spamming opinions as described for peer-to-peer online services.

According to the New York Times, up to one third of all positive online Internet reviews may be falsified. Bing Lu, a data-mining expert at the University of Illinois, Chicago is quoted by the New York Times that the “wheels of online commerce run on positive reviews [and] . . . about one-third of all consumer reviews on the Internet are fake.” (New York Times, Aug. 26, 2012, Is That Review a Fake?, David Streitfeld). The NYT presents an increasingly widely held conclusion that it is nearly “impossible” to discern when positive reviews are published by the marketers or retailers, by the authors themselves using pseudonyms, by customers who receive a deal from a merchant in exchange for providing a positive review, or by a hired third-party publicity service. A 2010 study by Cone Inc. Market research states that more than 80 percent of consumers go online to obtain information about that product or service “before deciding to purchase it.” (http://www.coneinc.com/stuff/contentmgr/files/0/57cbc4124b1ea562f11290ad6dda9277/files/20 10_on line_influence_trend_tracker_factsheet_final.pdf). The same study concluded that more than 75 percent of consumers purchase an item after finding positive reviews online.

The NYT further noted, “Consumer reviews are powerful because, unlike old-style advertising and marketing, they offer the illusion of truth.

They purport to be testimonials of real people, even though some are bought and sold just like everything else on the commercial Internet.” Supporting the NYT opinion, an April 2012 academic paper, Estimating the Prevalence of Deception in Online Review Communities presented by professors Ott, Cardie, and Hancock opined: “Consumers rely increasingly on user-generated online reviews to make, or reverse, purchase decisions. Accordingly, there appears to be widespread and growing concern . . . for posting deceptive opinion spam . . . Indeed, empirical, scholarly studies of the prevalence of deceptive opinion spam have remained elusive. One reason is the difficulty in obtaining reliable gold-standard annotations for reviews, i.e., trusted labels that tag each review as either truthful (real) or deceptive (fake)” (http://www2012.org/proceedings/proceedings/p201.pdf).

The Federal Trade Commission is hard pressed to recognize and police deceptive opinion spamming creating a need for an alternative method to help consumers make informed decisions. This is especially important as for-profit entities and persons increasingly hire or orchestrate positive reviewers to bolster sales. Customers may need to be provided with, and to some extent protected by, being furnished with objective non-aligned opinions.

The Commercialization of Originator/Subject Matter Experts

Renowned international, national, and local personalities, celebrity performers, authors, performers, artists, comedians, magicians, professors, instructors, teachers, athletes, lecturers and other overall subject matter experts in any field, craft or industry (herein also collectively known as originators/subject matter experts (O/SME)) have commercialized their specialized knowledge, abilities, memoires, and experiences through published works, such as books, DVDs, apps, videos, CDs, apps and other tangible goods and work-product mediums. These same O/SMEs often provide services related to their respective expertise, including, but not limited to, lectures, instruction, guest appearances and any other commercial in-person or proxy-person through an electronic viewable medium appearance or affiliates (including but not limited to an understudy, assistant instructor, band member, co-author, co-inventor, team-mate, etc.). Notably, tangible goods available for ecommerce sale are often based and derived from previous commercial performances or the specialized services, memoires, and experiences of the O/SME. These O/SMEs are often the subject of media attention and review by professional, third party publications.

Customers who buy a product of an O/SME usually do not have the opportunity interact with or meet O/SMEs. If these same customers could avail themselves of the O/SME's services and expertise for a fee, they may likely do so. As a result, customers might be interested in attending an in-person O/SME fee based event, appearance, lecture, or course or similar events sponsored by an affiliate of the O/SME. This supposition is likely to be particularly true if the O/SME or affiliate is performing, instructing, lecturing or presenting in geographic proximity to the potential customer or in a desirable location the potential customer may wish to visit (destination/location). Often, the O/SME has a website that lists upcoming appearances.

Online shopping continues to grow rapidly, especially, as customers seek reputable vetted services through Internet searches. According to the Wall Street Journal, Internet retail sales in the U.S. will grow 10% a year through 2015 as shoppers spend more time online. (Wall Street Journal Blog, Feb. 27, 2011. (Wall Street Journal Blog, Feb. 27, 2011, http://blogs.wsj.com/digits/2011/02/27/e-commerce-will-keep-rolling-research-firm-says/). According to a Feb. 27, 2012 Forrester Research report, U.S. ecommerce sales grew 12.6% in 2010 to $176 billion. That total will grow to $279 billion in 2015 Forrester research concludes.

Alongside product evaluations, reviews of performers and professional service providers, through social media/networks, are becoming increasingly important and commonplace. Specific peer-to-peer vetting entities, such as the Angie's List®, InsiderPages® or Yelp®, in exchange for a membership fee, help customers screen and source products and services through other customer reviews or peer feedback. Prior to these types of community-based reviews, especially those found on the Internet, other than simple word of mouth recommendations, vetting services provided by service providers was notoriously difficult. Resulting customer disappointment and travails are commonplace. This type of online public vetting and product/service reviews heavily influences a customer's decision to purchase a product or service.

An Aug. 25, 2012 article from the New York Times (NYT) noted: “Reviews by ordinary people have become an essential mechanism for selling almost anything online . . . In many situations, these reviews are supplanting the marketing department, the press agent, advertisements, word of mouth and the professional critique.” (New York Times, Aug. 26, 2012, Is That Review a Fake?, David Streitfeld).

Cone, Inc., a research firm, found that negative reviews strongly influence the purchase decisions of customers: 89 percent of consumers trust online reviews, and while 80 percent of consumers have changed their mind about purchases based on negative information that they found online, 87 percent claim that positive reviews reinforce their purchasing decisions. Website magazine states regarding the Cone Inc. study, “According to the study, 69 percent go online to research a product or service, 64 percent search for consumer reviews, 50 percent search for rating websites, 43 percent search for opinions from experts, 42 percent read articles or blog posts about products or services, and 12 percent solicit opinions from their social networks.” (www.coneinc.com/stuff/contentmgefiles/0/57cbc4124blea562f11290ad6dda9277/files/2010_o nline_influence_trend_tracker_factsheet_final.pdf).

As a result of the difficulty for consumers of O/SME services, as well as products, there is a need for an improved way for consumers to assess the quality of O/SMEs.

### SUMMARY

The principles of the present invention provide for a vetting organization service or service provider to vet originators/subject matter experts (O/SMEs) in an independent, methodical manner that offers an unbiased review for consumers of services of O/SMEs to trust when making purchasing or hiring decisions in an online forum. The principles of the present invention further provide for a third party source of products and/or services, such as (i) online book and product sellers and (ii) online services listing websites, or a content posting website, such as YouTube®, to offer and/or sell services of O/SMEs based on vetting results of the vetting service, thereby limiting liability of the third party service in offering those services.

One embodiment of a system for offering vetted services of an originator/subject matter expert (O/SME) by a third party source of products and services of multiple O/SMEs may include a content data repository configured to store data associated with the O/SME. The data may be inconclusive of product or service content representative of products or services being offered by the O/SME. A processing unit may be in communication with the data repository, and be configured to collect, from the data repository, select data associated with the O/SME. An O/SME vetted data repository configured to store vetting data representative of vetting results of the O/SME may be queried by the processing unit. In response to the processing unit receiving vetting data indicative of the O/SME having a vetting score at or above a passing vetting threshold value, an interactive booking feature may be displayed in relation to the selected data associated with the O/SME and activated to enable a user to book services with the O/SME. Otherwise, if the vetting score is not at or above the passing vetting threshold value, then the interactive booking features may not be enabled to be displayed and activated.

One embodiment of a method for offering vetted services of an originator/subject matter expert (O/SME) by a third party source of products and services of multiple O/SMEs may include storing, in a content data repository, data associated with the O/SME, the data inconclusive of product or service content representative of products or services being offered by the O/SME. Select data associated with the O/SME may be collected by the processing unit from the data repository. An O/SME vetted data repository configured to store vetting data representative of vetting results of the O/SME may be queried. In response to receiving vetting data indicative of the O/SME having a vetting score at or above a passing vetting threshold value, an interactive booking feature may be displayed in relation to the select data associated with the O/SME and activated to enable a user to book services with the O/SME. Otherwise, the interactive booking feature may not be displayed and activated.

One method of vetting an originator/subject matter expert (O/SME) may include collecting, by a processing unit, vetting data associated with the O/SME from a plurality of data sources. Rules for vetting the O/SME may be established. A vetting result based on the collected vetting data and established rules may be generated by the processing unit. The vetting result may be stored in a data repository. Responsive to receiving a query from a third party source via a communications network, the vetting result may be communicated to the third party source.

One embodiment of a system for vetting an originator/subject matter expert (O/SME) may include a data repository configured to store vetting data associated with the O/SME. A processing unit may be in communication with the data repository, and be configured to collect the vetting data from multiple data sources via a communications network. A vetting result may be generated based on the collected vetting data and rules established for vetting the O/SME. The vetting result may be stored in the data repository. Responsive to receiving a query from a third party source via the communications network, the vetting result may be communicated to the third party source.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of an illustrative online environment in which online sellers of goods and services or third party sources may offer services of O/SMEs based on vetting results of a vetting organization or service of the O/SMEs in accordance with the principles of the present invention;

FIG. 2 is an illustration of an illustrative network environment in which third party sources may offer services of O/SMEs based on vetting results of a vetting organization or service of the O/SMEs;

FIGS. 3A and 3B (collectively FIG. 3) is an interaction diagram that provides an illustrative process of an O/SME, third party source, vetting organization, and online consumer to interact with one another in selling services of the O/SME by the third party source;

FIG. 4 is a block diagram of illustrative modules executable by a server of a third party source that may provide service offerings of a vetted O/SME;

FIG. 5A is a screen shot of an illustrative online seller of media (e.g., books and videos) that, in addition to offering media produced by an O/SME for sale, also offers services of the O/SME based on vetting by a vetting service;

FIG. 5B is a screen shot of an illustrative online media posting service of digital media that also offers services of an O/SME based on vetting by a vetting service;

FIG. 6 is a screen shot of an illustrative vetting summary review screen for a vetting professional or operator of a vetting organization to review vetting results of an O/SME;

FIG. 7 is a flow diagram of a illustrative vetting process in accordance with the principles of the present invention; and

FIG. 8 is a block diagram of illustrative modules executable on a computing system of a vetting service.

### DETAILED DESCRIPTION

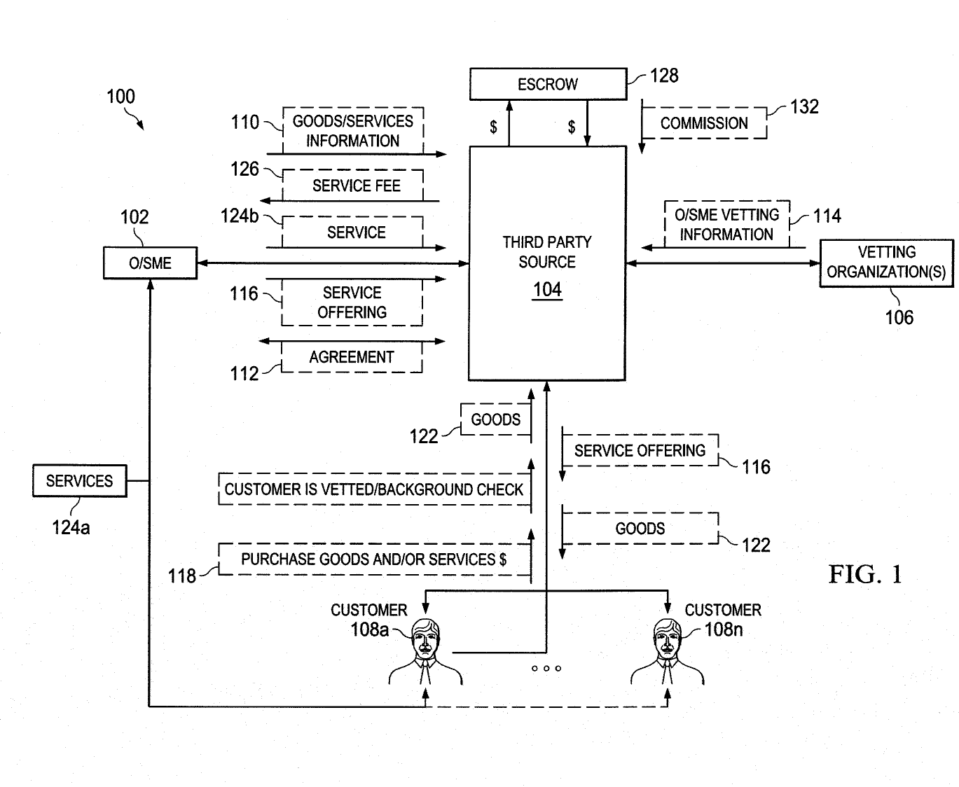

With regard to FIG. 1, an illustration of an illustrative online environment 100 in which online sellers of goods and services or third party sources may offer services of originators/subject matter experts (O/SMEs) is shown. The offered services may be based on vetting results of a vetting organization or vetting service of the O/SMEs in accordance with the principles of the present invention. The environment 100 is shown to include an O/SME 102, third party source 104, vetting organization or service 106, and online customers 108a-108n (collectively 108). Although only one of each of the O/SME 102, third party source 104, and vetting organization 106 are shown, it should be understood that multiple ones of each of the different parties may operate within the online environment 100 in accordance with the principles of the present invention. As previously described, an O/SME may be any person or organization having a certain level of knowledge that qualifies that person or organization to be a subject matter expert in a particular craft, field, or industry. A vetted O/SME may be an O/SME who has been vetted by a vetting organization. As an example, an instructor of martial arts may have a certain amount of expertise in martial arts that qualifies that instructor to be considered a subject matter expert. However, simply being a professional in a particular field or craft may not qualify that individual to be a vetted subject matter expert as provided herein. Rather, in order to be considered a vetted subject matter expert in accordance with the principles of the present invention, the person or organization may be vetted in order to receive a vetting rating (e.g., vetting rating of 7.2) and/or result (e.g., pass or fail) based on certain vetting criteria or rules as further described herein. A qualified O/SME may be an O/SME who receives a vetting rating above a predetermined threshold value. The predetermined threshold value may be established by the vetting organization 106 or third party source 104.

The third party source 104 may be an online seller of goods, online posting service, and/or online repository of content for view by users that is not controlled by the O/SME 102. That is, the third party source may be an online seller of goods, services, content, or otherwise of O/SMEs. As an example, the third party source 104 may be an online bookseller. In another example, the third party source 104 may be an online video repository available for individuals to view content of O/SMEs. In yet another example, the third party source may be an online posting service for service providers. There are many other examples of third party sources that sell, post, or distribute content and/or services of O/SMEs, including online periodicals, online reviewers, online mapping systems, or otherwise.

The vetting organization or vetting service 106 may be a service provider that performs vetting services of O/SMEs as well as, optionally, customers of the third party sources 104. The vetting service may be independent from the third party source 104 or may be part of the third party source 104. The vetting organization 106 may be tasked with performing investigations, background checks, or otherwise vetting O/SMEs to minimize the chance that an O/SME is fraudulent, not what he or she purports him or herself to be, has a bad reputation in some manner, or otherwise. The vetting organization 106 may be independent, thereby providing users or customers who might be seeking to purchase services of O/SMEs with confidence that qualified O/SMEs are reputable and present minimal or no danger, both economically and physically, to a customer of services of the O/SME. The vetting organization 106 may also perform vetting services for the third party source 104 to ensure that customers who purchase services of services meet certain vetting thresholds to reduce risk of physical or economic harm to the O/SME 102.

The O/SME 102 may communicate goods and/or services information 110 to the third party source 104 for inclusion on a website or app of the third party source. The goods and/or services information may include images, videos, text, graphics, or any other form of media content that the third party source 104 may make available to the users 108 for viewing and/or purchasing of the goods and/or services of the O/SME 102. In the event that the O/SME 102 may wish for the third party source 104 to sell services of the O/SME 102, then an agreement 112 may be formed between the O/SME 102 and third party source 104. The agreement 112 may establish the types of services that the third party source 104 may offer of the O/SME 102. In addition, the agreement 112 may set forth compensation for the third party source 104 if services of the O/SME 102 are sold or referred by the third party source 104.

As part of the agreement 112, the O/SME 102 may authorize the third party source 104 to have an independent audit or vetting performed of the O/SME 102 by the vetting organization 106. The vetting organization 106 may receive O/SME information (not shown), such as name, address, social security number, tax ID number, and so forth, from the third party source 104. The vetting organization 106 may vet the O/SME 102 and provide the third party source 104 with O/SME vetting information 114, which may be a vetting result or vetting score, as further described herein.

The O/SME 102 may provide the third party source 104 with service offering(s) 116 that the third party source 104 may offer to users 108. The service offerings 116 may include a title of the service(s), description of the services, dates and times when the O/SME 102 may make the services available to users 108, dates of performances, addresses or locations, or any other information that is helpful to a user in booking services of the O/SME 102, whether those services are private, group, or audience-based. The difference between the service offering(s) 116 and the goods and/or services information 110 is that the service offering(s) 116 are personal services that the O/SME 102 is willing to provide customers in person or virtually (e.g., mentoring services), whereas the goods and/or services information 110 includes information associated with goods and general services that the O/SME 102 offers, but not necessarily those that are to be booked in the same manner as the service offerings 116.

The service offerings 116 may be communicated by the third party source 104 to the users 108 via a communications network, such as the Internet, mobile communications system, or other communications system to an electronic device, as understood in the art. The customers 108 may purchase goods and/or services 118 from the third party source 104. In purchasing the services of the O/SME 102, interactive booking feature(s) that enable the users 108 to book services from the O/SME 102 may be provided in association with goods or content of the O/SME 102 by the third party source 104. In one embodiment, the interactive booking feature(s) may be displayed and active if the O/SME 102 has a vetting result that is above a threshold value. The threshold value may be established by the vetting organization 106 or third party source 104. In purchasing the services of the O/SME 102, a booking interface or display may be provided to a user to schedule or otherwise book with the O/SME 102 either via the third party source 104 or directly with the O/SME 102 (with some referral tracking so that both the third party source and O/SME can identify and manage customer referrals). In the event that the user 108a purchases goods 122 from the third party source 104, then the third party source 104 may send the user 108a the goods 122 via a postal service or make available at a physical location of the third party source 104 for the user 108a to pick up. In the event that the user 108a purchases services 124a of the O/SME 102, then the user 108a may physically meet the O/SME 102. Alternatively, rather than the user 108a having to physically meet the O/SME 102, the O/SME 102 may provide a virtual meeting to provide services 124b to the customer 108a. In one embodiment, the virtual meeting may be performed via a user interface of the third party source 104 or directly between the O/SME 102 and user 108a via an interface independent of the third party source 104. The virtual meeting may be a video chat, audio chat, or any other form of communication, as understood in the art.

As a result of the user 108a purchasing in-person services 124a or virtual services 124b of the O/SME 102, the third party source, after collecting payment from the user 108a may pay a service fee 126 to the O/SME 102. The third party source 104 may also keep a commission or other payment as defined in the agreement 112. In one embodiment, an escrow agent 128 may be utilized to collect service payment 130 from the user 108a and pay out the respective payments to the O/SME 102 and third party source 104 after services have been rendered by the O/SME 102 to the user 108a. For example, the service fee 126 may be paid by the escrow agent 128 (i) after either of the services 124a or 124b have been rendered and (ii) there is no dispute by the user 108a of the quality and performance of the services 124a or 124b to the O/SME 102, and a commission 132 may be paid by the escrow agent 128 to the third party source 104 at the time of paying the service fee 126.

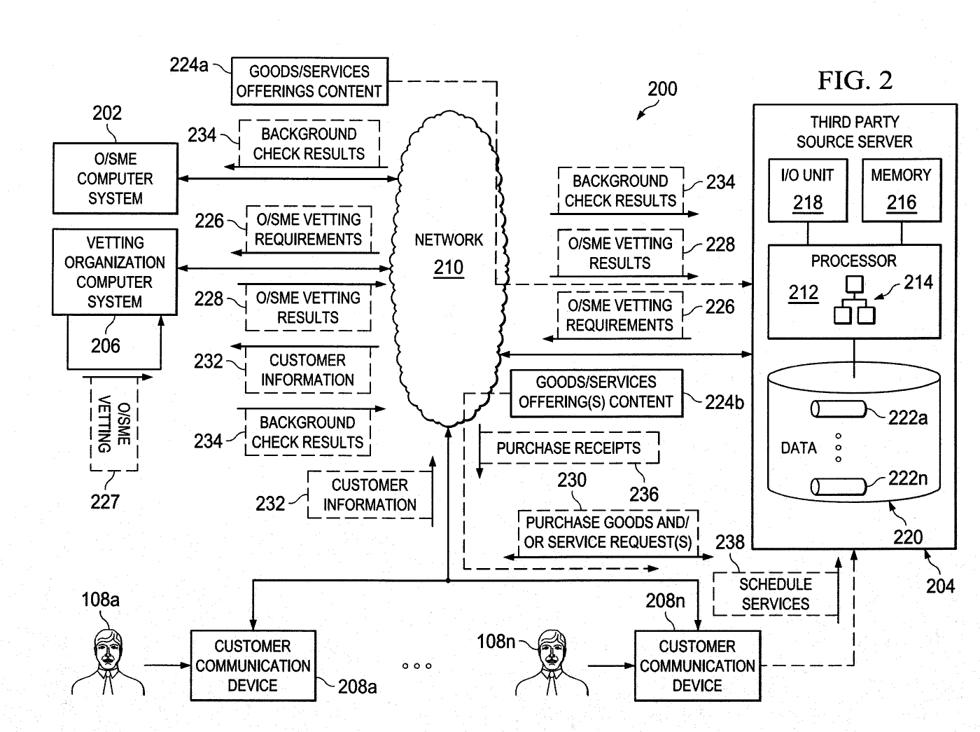

With regard to FIG. 2, an illustration of an illustrative network environment 200 in which third party sources may offer services of O/SMEs based on vetting results of a vetting organization or vetting service of the O/SMEs is shown. The network environment 200 may include an O/SME computer system 202, third party source server 204, vetting organization computer system 206, and communication devices 208a-208n (collectively 208) of the users 108. The O/SME computer system 202 may be any type of computer system, including a server, personal computer, or mobile device. The communications devices 208 may be a personal computer, mobile device, gaming device, or any other electronic device capable of communicating via a communications network 210 to access a website, mobile app, or any other form of communication (e.g., interactive television) that a third party source may offer vetted services of an O/SME.

As shown, the third party source server 204 may include a processing unit 212 that is configured to execute software 214. The processing unit 212 may be in communication with a memory 216 configured to store data and software instructions, input/output (I/O) unit 218 configured to communicate over one or more communications networks using respective communications protocols, as understood in the art, and data repository 220 configured to store one or more data repositories 222a-222n (collectively 222). The processing unit 212 may include one or more computer processors that execute software 214 to provide offerings of goods and/or services of O/SMEs, as described herein.

The O/SME computer system 202 may be configured to communicate goods and/or service offerings content 224a to the third party source server 204 for storage in the data repositories 222. The third party source server 204 may thereafter be utilized to communicate the goods/service offerings content 224a to the communications devices 208 as goods/service offerings content 224b in the same or different format than received from the O/SME computer system 202. As an example, the goods/service offerings content 224b may be communicated with other goods/service offerings content (not shown) of other product or service providers (e.g., other book authors or publishers) for posting on a website or otherwise. The goods/service offerings content 224a and 224b may include both general services being offered as well as personal services being offered. In one embodiment, prior to posting service offerings by the O/SME, O/SME vetting requirements 226 may be communicated from the third party source server 204 to the vetting computer system 206. The O/SME vetting requirements 226 may be established by the third party source to ensure that the O/SME meets the third party source's quality as a service provider. Alternatively, rather than the third party source establishing the O/SME vetting requirements, the vetting organization may establish the O/SME vetting requirements 226 and the third party source server 204 may be configured to communicate O/SME information (not shown) to the vetting organization computing system 206 so that the vetting organization may perform vetting on the O/SME.

The vetting computer system 206 may perform O/SME vetting 227, which may include communicating vetting requests via the network 210 to data repositories located (not shown) on or available via the network 210. The O/SME vetting 227, for example, may include communicating with databases of publications, crawling the Internet to identify peer-to-peer reviews of an O/SME, looking up financial records of the O/SME in public or private databases of governmental and financial institutions, looking up criminal records of the O/SME in governmental databases, and so forth. The O/SME vetting 227 may further generate O/SME vetting results 228 for communication back to the third party source server 204 for storage in the data repositories 222 so that the third party source server 204 may determine whether or not to post services of the O/SME for booking by the users 108. Alternatively, the O/SME vetting results 228 may simply be a pass or fail based on the O/SME vetting requirements 226 provided by the third party source server 204 or established by the vetting organization and set on the vetting organization computer system 206.

In response to the service offerings being presented to the user 108n via the communications device 208n, a purchase goods and/or services request 230 may be communicated to the third party source server 204 for purchasing goods and/or services. In making the purchase, customer information 232 may be communicated to the third party source server 204 for making the purchase of the goods and/or services. In one embodiment, the customer may have already established his or her customer information 232 by logging into an account of the third party source server 204. Alternatively, the customer information 232 may be communicated after submitting to purchase goods and/or services request 230.

In one embodiment, the third party source server 204 may be configured to communicate the customer information 232 to the vetting organization computer system 206 for vetting or otherwise performing a background check of the customer for protection of the O/SME. The vetting organization computer system 206 may vet the customer by performing financial, criminal, and general reputation checks of the customer or user 108n and communicate customer background check results 234 to the third party source server 204. The customer background check results 234 may be communicated to the O/SME computer server 202 via the third party source server 204 to enable the O/SME to review the background checks prior to engaging the customer in-person or even virtual services. The third party source server 204 may communicate purchase receipts 236 to the communication device 208n for purchasing goods and/or services of the O/SME. In response to or as part of the customer 108n requesting to purchase services of the O/SME, the customer 108n may schedule purchased services 238 with the third party source server 204 or directly with the O/SME computer system 202, as further described herein.

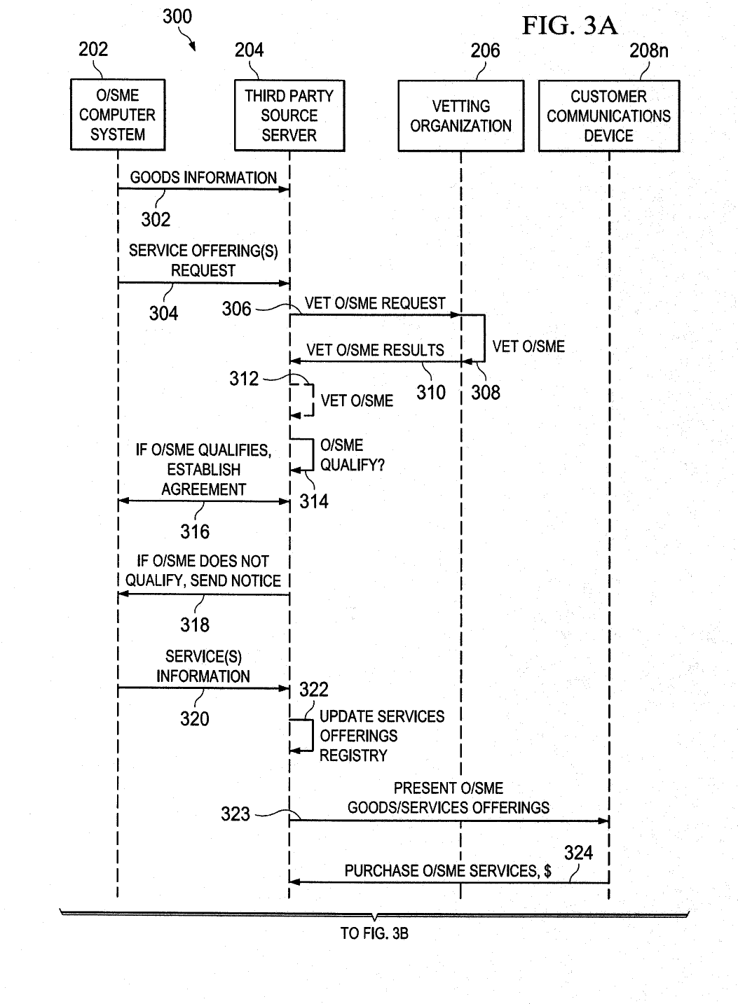

With regard to FIG. 3, the O/SME computer system 202, third party source server 204, vetting organization computer system 206, and communication device 208n of a customer are shown to be in communication with one another to provide vetting and sales of services of an O/SME in accordance with the principles of the present invention. A process 300 may include communicating goods information 302 by the O/SME computer system 202 to the third party source server 204 for storage thereby. At step 304, a service offering(s) request may be communicated by the O/SME computer system 202 to the third party source server 204. The request at step 304 may be part of an application process offered by the third party source to sell services of the O/SME and include information that enables the third party source server 204 to provide or communicate information of the O/SME in a vet O/SME request 306 to the vetting organization computer system 206. At step 308, the vetting organization computer system 206 may be utilized to vet the O/SME. As previously described, in vetting the O/SME 308, the vetting organization computer system 206 may utilize data associated with the O/SME stored by the vetting organization computer system 206 or may communicate with other data repositories located on a communications network, such as the Internet, to gather vetting information. At step 310, the vetting organization computer system 206 may communicate vetting O/SME results of the O/SME to the third party source server 204. As an alternative to the third party source using a vetting organization to perform vetting of the O/SME, at step 312, the third party source server 204 may be utilized to vet the O/SME. In either case, the third party source server 204 may be configured to determine whether the O/SME qualifies to have services of the O/SME posted or otherwise sold by the third party source server 204 at step 314.

At step 316, if the O/SME qualifies, then an agreement may be made between the O/SME and third party source. In one embodiment, the agreement may be transacted via the O/SME computer system 202 and the third party source server 204. If the O/SME does not qualify for services to be displayed or sold by the third party source, then at step 318, a notice may be sent by the third party source server 204 to the O/SME computer system 202 to inform the O/SME that he or she does not qualify as a subject matter expert, or at least a reputable subject matter expert, and, therefore, the third party source is not going to sell services for the O/SME. It should be understood that a denial in selling services of the O/SME by the third party source does not mean that the third party source will not continue to sell products and post services available by the O/SME, but rather the third party source will not directly sell or make available services of the O/SME to customers of the third party source. If the O/SME meets the qualifications of the third party source, then the O/SME computer system 202 may be utilized to communicate service(s) information 320 of the O/SME to the third party source server 204 for storage thereby. At step 322, the third party source server 204 may update a services offerings repository. At step 323, the third party source server 204 may communicate or present O/SME goods/services offerings to the communications device 208n of a user. The communications device 208n of the user may be a computer or mobile device, as understood in the art. The communication at step 322 may be as a result of the communications device 208n requesting to access or view the O/SME goods/services offerings as a result of a search, listing request, or otherwise online posting, as understood in the art.

At step 324, the communications device 208n may communicate a purchase O/SME services request to the third party source server 204. At step 326, an optional customer background check may be requested by the third party source server 204 to the vetting organization computer system 206. At step 328, in response to the request of step 326, the vetting organization computer system 206 may perform a background check of the customer, as previously described. At step 330, customer background check results may be communicated by the vetting organization computer system 206 to the third party source server 204. The results may be a score or simply a pass/fail indicator.

When the third party source sells services of the O/SME, a number of different payment options may be utilized. In one embodiment, money may be collected from the customer by the third party source in the form of a credit or debit card payment. Alternatively, the customer may pay the O/SME directly via a user interface or otherwise. In one embodiment, the third party source server 204 may be configured to receive payment from the customer and, optionally, escrow the payment. In one embodiment, at least a portion of the payment prior to the O/SME performing the services being purchased by the customer from the O/SME may be withheld. At step 334, a services purchase notification may be communicated by the third party source server 204 to the O/SME computer system 202.

At step 336, the O/SME computer system 202 may be in communication with the communications device 208n to enable the customer and O/SME to schedule services either in-person or online. Alternatively, rather than the O/SME computer system 202 being used to schedule the services, the third party source server 204 may be utilized to schedule the services with the communications device 208n of the customer. At step 338, the third party source server 204 may optionally be utilized to communicate a non-refundable deposit to the O/SME computer system 202 (or at least a receipt may be communicated to the O/SME of a deposit that may be directly made into a bank account of the O/SME or of a check being mailed to the O/SME, or otherwise).

After services have been rendered by the O/SME to the customer, at step 340, a services rendered notification may be made by the O/SME computer system to the third party source server 204 and/or communications device 208n of the customer so that a written record of services having been performed by the O/SME to the customer may be made. At step 342, a dispute wait period may be performed by the third party source server 204, where the dispute wait period may be a certain period of time by which the customer has to challenge whether or not the services were rendered and met the expectations of the customer. At step 344, after the dispute wait period, a services payment may be made by the third party source to the O/SME and a services payment receipt may be made by the third party source server 204 to the O/SME computer system 202. The services payment may be a balance of the payment due to the O/SME if a nonrefundable deposit was made. The services payment may also have a deduction for the third party source having sold the services of the O/SME. At step 346, a commission or other payment may be made to the third party source as part of the selling of the services of the O/SME. At step 348, a receipt of the services rendered and payment tendered may be communicated from the third party source server 204 to the communications device 208n may be communicated from the third party source server 204 to the communications device 208n. It should be understood that the process provided in FIG. 3 are illustrative in that additional and/or alternative steps and functions may be made in accordance with the principles of the present invention for selling services of the O/SME by the third party source to customers.

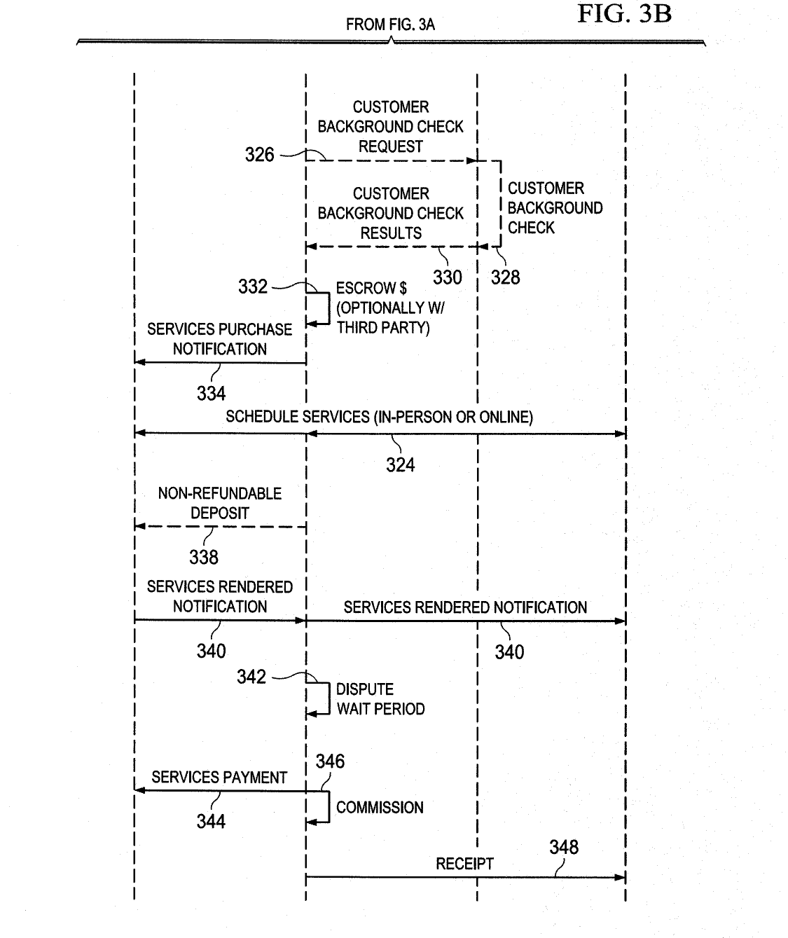

With regard to FIG. 4, a block diagram of illustrative modules 400 for use by a third party source in selling services of an O/SME is shown. The modules 400 may include a collect O/SME data module 402 that may be utilized to collect O/SME data from an O/SME. The module 402 may receive O/SME data and store the data in a data repository by a server of the third party source. The module 402 may be configured to collect a minimum set of information , from the O/SME. In addition, the collect O/SME data module 402 may be configured to collect vetting results of O/SMEs that may be performed by the third party source or independent vetting organization, as previously described herein. The results of the vetting may be stored in association with the O/SME data. The collect O/SME data module 402 may further be configured to collect product and/or services information and content of products and services being offered by the O/SME. For example, information about books, videos, services, and actual content may be collected by the module 402.

An access O/SME data repository module 404 may be configured to enable potential customers or users to access the data collected by the module 402. In providing access, the module 404 may be configured to enable a user to perform a search of data being stored or accessible by a server of the third party source. It should be understood that searching the data of O/SMEs may take on a wide variety of options, as understood in the art. Once accessed, data associated with the O/SME may be communicated and displayed on a communications device of a user via a user interface, such as a website, app on a mobile device, display on an interactive television, or otherwise, as understood in the art.

A manage interactive booking features module 406 may be configured to store information associated with booking services of an O/SME that may be used in presenting services of O/SMEs to potential customers of the services of the O/SMEs. The booking features may be features presented on a user interface that enable the customer to book services of the O/SME. In managing the interactive booking features, the module 406 may be configured to store particular types of booking features or information associated with booking features that enables the booking features to be posted in association with product and/or services of the O/SME by the third party source.

A display interactive booking features module 408 may be configured to display interactive booking features of services of an O/SME by a third party source. The module 408 may be configured to determine whether or not the O/SME has met vetting criteria or vetting threshold that enables the services of the O/SME to be offered to customers. If the O/SME has not met the criteria, then the interactive booking features may be prevented from being displayed or displayed in a “grayed out” or inactive manner, as understood in the art. If the O/SME has met the vetting criteria, then the booking features may be displayed in an active mode, as understood in the art. Depending upon the type of services being offered and whether the third party source sells the services of the O/SME directly or requires or enables the O/SME to schedule services with a purchasing customer directly, the interactive booking features may take different forms. Alternatively, the interactive booking features of the third party source may be identical for all services being offered by all O/SMEs.

A book O/SME services module 410 may be configured to enable the third party source to book services of the O/SME. The module 410 may be configured to post a listing of services being offered by the O/SME, dates of availability of the services by the O/SME, locations of the O/SME in which the services are being offered, dates and times, of the services of the O/SME being offered, and so forth. In one embodiment, the services being offered by the O/SME may be performed in-person or virtually (e.g., via a video interface), and the module 410 may accommodate for the various types of services being offered and cause a display of a user interface to be presented to the user with the various options of services being offered by the O/SME. The various options of the services being provided by the O/SME may be established by module 402 that collects data from the O/SME, where the data may include the various services being offered by the O/SME, inclusive of dates, times, locations, in-person, virtual or online, and any other information associated with the O/SME providing services that are available for sale by the third party source to customers.

An accounting module 412 may be configured to collect money by customers for services being offered by the O/SME and account for the payments made by the customers, including accounting for guaranteed or required deposits to the O/SME for booking services, paying money to an escrow prior to the services being performed, transaction or commission fees to be paid to the third party source, or other accounting to be made in collecting money or recording bookings of the O/SME by the third party source.

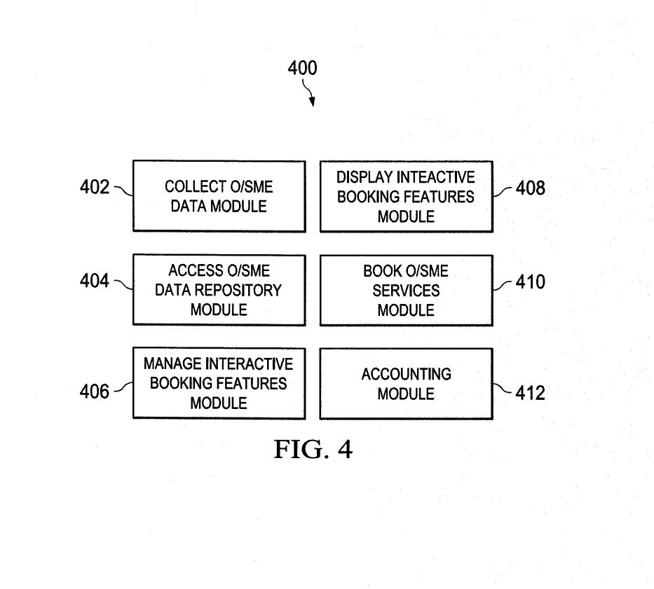

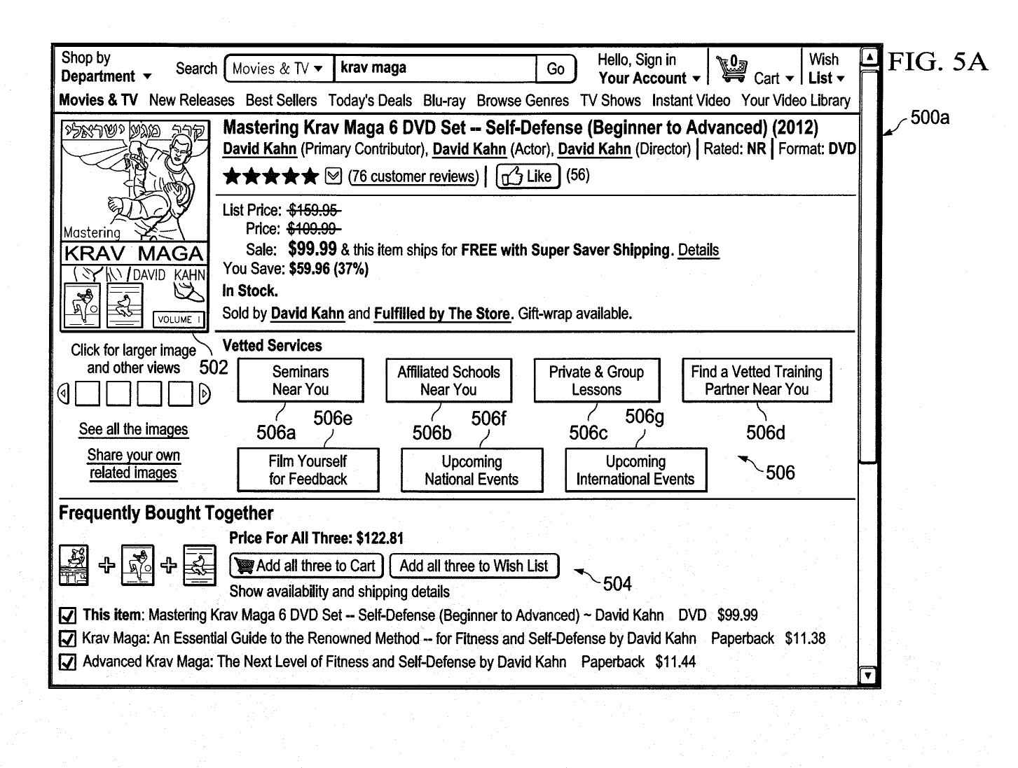

With regard to FIG. 5A, a screenshot of an illustrative graphical user interface 500a showing data or content 502 associated with a seller of goods, in this case a DVD set, is shown. The content 502 may include an image of the product, information associated with the product, information associated with the O/SME of the product, and so forth. Interactive purchasing features 504 may enable a user to purchase products of the O/SME. An originator/subject matter expert (O/SME) may be considered a qualified O/SME if he or she (or an organization) has been vetted and qualifies as an O/SME. In this case, because the seller has qualified as being an O/SME by being vetted, a vetted services section 506 in which interactive booking features of services by the O/SME may be displayed and active. The interactive booking features may include features 506a-506g, which are soft-buttons that enable the user to select to book services with the O/SME. As shown, the interactive booking features may include a “seminars near you” soft-button 506a, “affiliated schools near you” soft-button 506b, “private and group lessons” soft-button 506c, “find a vetted training partner near you” soft-button 506d, “film yourself for feedback” soft-button 506e, “upcoming national events” soft-button 506f, and “upcoming international events” soft-button 506g. Other soft-buttons, such as “book a virtual lesson” soft-button (not shown), may also be provided. Through each of these soft-buttons, which, as previously described, may be made active if the O/SME qualifies as a qualified O/SME after being vetted, a user may be presented with another user interface that enables the user to schedule services or attend events that the O/SME is conducting. Such services may range from attending a performance or lesson in person or online, attending a group session being offered by the O/SME, to having a private session in a location of the O/SME or the booking customer. The range of each of the services may be quite varied and have different prices associated therewith.

With regard to FIG. 5B, a screenshot of another illustrative graphical user interface 500b that is used to post content for users to view is shown. In association with the content, in this case a video 508 available for view by the user, a vetted services section 512 may include a number of different interactive booking features. As previously described, if the O/SME is determined to be a qualified O/SME as a result of being vetted by the third party source, in this case a posting service for content to be viewed by others, or an independent vetting service, as previously described, then the interactive booking features may be displayed and active for the viewer to select to book services with the O/SME. In addition to providing for a posting of content, the graphical user interface 500b may also provide for a listing of links 510 at which products of the O/SME may be purchased. The interactive booking features may include soft-buttons 512a-512g, which may match those of the interactive booking features 506 of FIG. 5A. As previously described, the interactive booking features may be varied depending upon the O/SME, third party source, or otherwise. In one embodiment, a logo 514, in this case, an “IV” logo, may be displayed in association with the interactive booking features 512 to allow users to recognize that the vetted services of the O/SME have been vetted by a particular vetting organization.

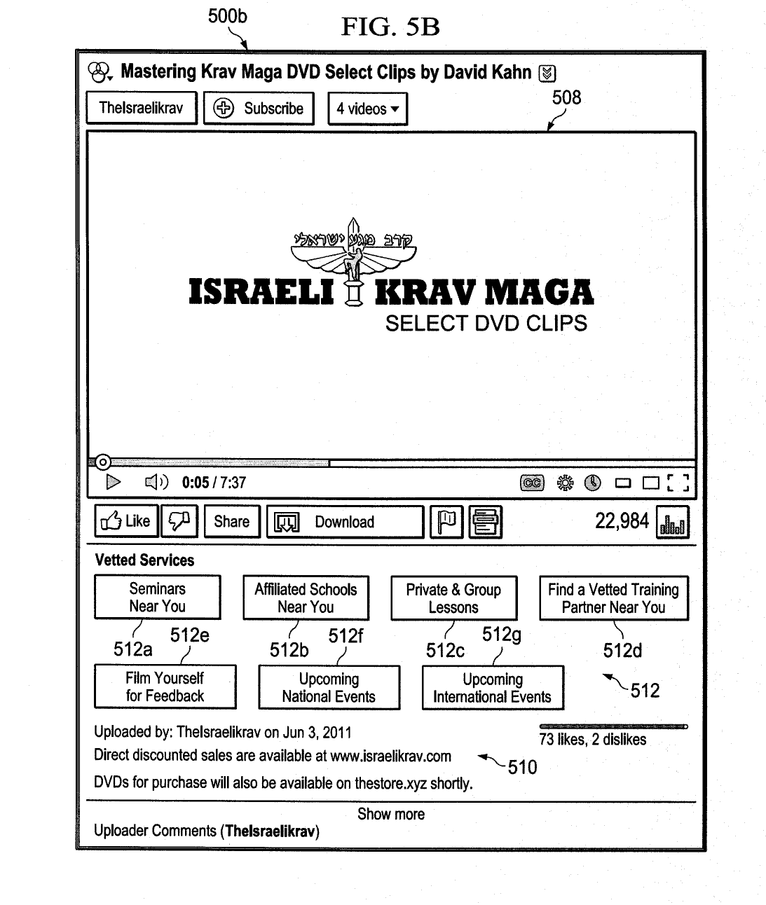

With regard to FIG. 6, a screenshot of an illustrative graphical user interface 600 is shown. The GUI 600 is provided to an operator of a vetting organization to enable the operator to view vetting scores for different vetting categories, inspect the information behind the scores in each category, and enter an approval. As shown, the vetting categories 602 may include ten different vetting categories, such as:

| | | | |
|---|---|---|---|
| 1. | Authored Written Works | 6. | Professional Organizations |
| | | | Recognition |
| 2. | Starred in or Produced Video Works | 7. | Legal Records |
| 3. | Media Recognition or Accolades | 8. | Professional Liability |
| | | | Insurance |
| 4. | Peer-To-Peer and/or Public Review | 9. | Service Quality/Scalability |
| 5. | Endorsements/Education | 10. | Geographic Footprint |

In association with each of the different categories, vetting scores 604 may be listed. The vetting scores 604 may be listed in editable text or data fields, as understood in the art. Also associated with each of the categories may be an inspection tool 606 that enables the operator to inspect data that was used in determining the vetting score. In selecting a tool associated with a category, a user interface, such as a pop-up window, another screen, or new window, with vetting information that was used in making the determination of the vetting score may be displayed. In one embodiment, the vetting organization may have an operator approve of each vetting score, and the operator may create an approval identifier 608 by clicking or otherwise, thereby allowing the vetting organization to know that a human has verified the vetting results. Alternatively, the process may be fully automated so that an operator does not have to approve or otherwise inspect the vetting performed for each of the categories 602.

Vetting results 610 and 612 may also be shown on the GUI 600. The vetting results 610 may be a statistic, such as a cumulative sum, of the vetting scores 604. Alternatively, the vetting results 610 may be any other statistic that uses an arithmetic or mathematical computation. The vetting results 612 showing a pass may be an indicator that the vetting results 610, for example, are above a predetermined vetting results threshold or criteria that satisfies the vetting organization or the third party source. As further shown, a last date vetted input field 614 may be available for the operator to enter the date that the O/SME has been vetted. It should be understood that a variety of additional information and formats may be utilized to enable an operator of the vetting service to review and/or edit vetting data and results of an O/SME.

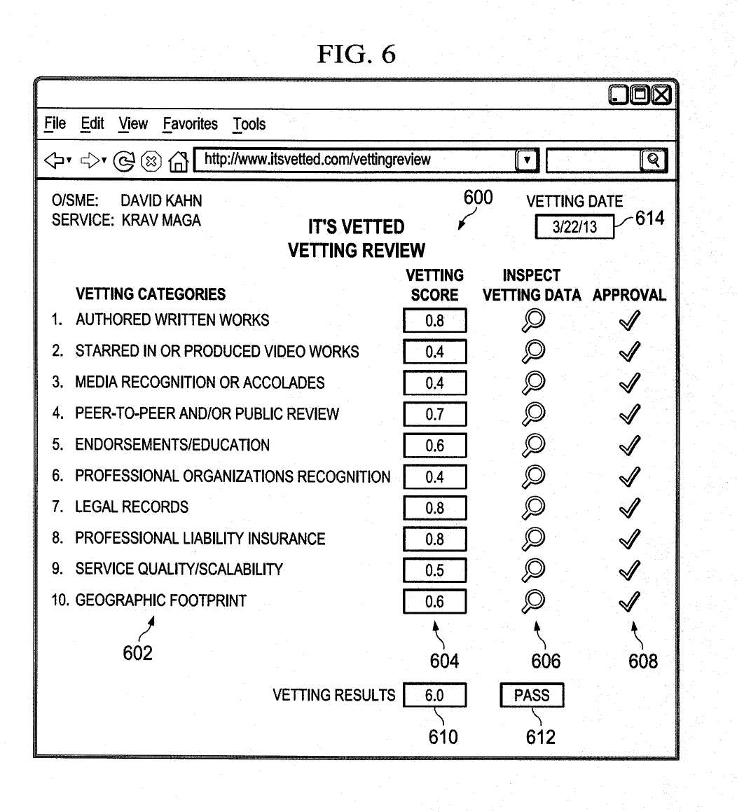

With regard to FIG. 7, a flow diagram of an illustrative process 700 for a vetting organization or service provider to perform in vetting O/SMEs is shown. The process 700 may start at step 702, where vetting data associated with an O/SME may be collected from multiple sources. The vetting data may be data associated with each of the categories 602 of FIG. 6. The sources from which the vetting data may be collected may be varied in location and scope as a result of the vetting data being generated and maintained by different organizations. For example, periodicals, such as newspapers, may store its data in a data repository owned by the periodical or publication. Legal documents may be stored with courts, state records, federal records, or other data sources, such as police records.

At step 704, rules for vetting an O/SME may be established. The rules may be established by the vetting organization based on orders of priority, which may vary depending upon a third party source having different priorities or types of O/SMEs that are being vetted. The rules may further include establishing weights, scales, or other factors that may be applied to vetting data associated with an O/SME. As an example, the rules may establish vetting categories in a particular order, where, if an O/SME does not satisfy a minimum vetting threshold for one category, that the vetting service will not perform vetting for additional categories. Alternatively, the vetting service may perform a vetting for all categories and weight each of the categories differently. Still yet, the vetting service may weight all the categories equally. It should be understood that the number of categories and weights applied to each of the categories may be varied depending upon the type of O/SME, type of service offerings being offered by the O/SME, or any other reason determined by the vetting service or third party source.

In one embodiment, the rules may be established to provide for a pass or fail vetting, where the pass or fail is based on a vetting result that is derived from individual vetting scores in different vetting categories meeting or exceeding a vetting threshold value. As an example, the vetting result may be a summation, average, or any other arithmetic or statistical computation. In one embodiment, when a pass vetting result occurs, a passing result may best established as a “low pass,” “pass,” or “high pass” to further distinguish the vetting results. From the distinguished passing vetting results, the third party source may provide the O/SME with the ability to offer different types of services. As an example, if an O/SME achieves a “low pass” vetting result, then the third party source may enable the O/SME to offer virtual services. If the O/SME achieves a “pass,” then the third party source may enable the O/SME to offer audience and group sessions. If the O/SME achieves a “high pass,” then the third party source may enable the O/SME to offer one-on-one sessions. It should be understood that in enabling the O/SME to offer these services based on different passing distinctions, that the third party source may simply limit the interactive booking features being provided to users via a website or app of a third party source to disable one or more booking features (e.g., enable a “book group session” booking feature (e.g., soft-button) and disable “book private session” booking feature).

At step 706, a vetting result based on vetting data and established rules may be generated. The vetting result may be a mathematical or grade that is calculated or determined based on individual vetting results for each vetting criteria or a simple pass/fail vetting result that is a Boolean. The vetting result being based on the vetting data may be calculated using a mathematical formula, such as addition and multiplication, include weights for each of the vetting categories, and follow rules that may be established by the vetting service and, optionally, third party source. Again, the vetting rules may be varied depending upon the type of O/SME, type of service being provided by the O/SME (e.g., personal service, service in a retail environment (e.g., dance studio), in-home service (e.g., personal training), virtual or online video service, conference call, and so forth).

At step 708, the vetting result may be stored in association with the O/SME. The vetting result may be a grade, Boolean value, or other vetting result. At step 710, the vetting result may be communicated to the third party source. In one embodiment, the vetting result may be communicated to the third party source in response to a request for a vetting result. Alternatively, the vetting result may be communicated to the third party source on a periodic basis, such as a quarterly basis or shorter, still yet, the vetting result may be communicated to the third party source independently or with other vetting information. In one embodiment, the vetting result may be a grade or value that is generated through an arithmetic computation, such as a score between zero and ten. Alternatively, the vetting result may be a Boolean value, such as pass or fail. As a result of the vetting result, the third party source may determine whether or not to make available services through interactive booking features, as shown in FIGS. 5A and 5B.

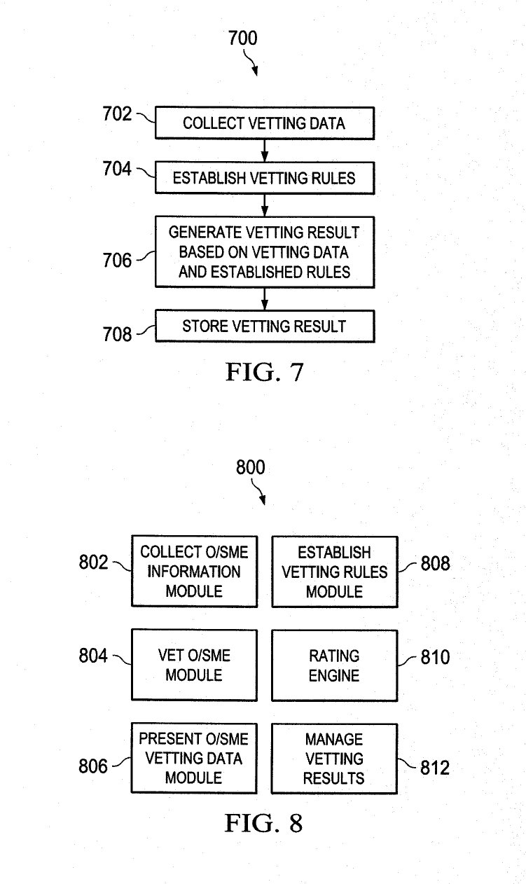

With regard to FIG. 8, a block diagram of modules 800 for use by a vetting organization in vetting O/SMEs are shown. The modules 802 may include a collect O/SME information module that is configured to use information, such as a social security number, name, address, or other information associated with an O/SME, and search data repositories locally or managed by other organizations to collect information about an O/SME. The information that is collected may be considered vetting information that the vetting service may use to vet the O/SME. The information may include a wide variety of information. It may come from structured or unstructured data sources. For example, a structured data source may be a data source that has bibliographic information about a book, movie, or other work, as understood in the art. An unstructured data source may be content that is posted on peer-to-peer websites or other publications that are free-flowing in nature.

A vet O/SME module 804 may be used to vet the O/SME based on the collected O/SME information performed by module 802. In vetting the O/SME, the module 804 may use a variety of different techniques, including applying a score based on whether or not the O/SME has published any works, has any criminal records, has any lawsuits, and so forth. In one embodiment, the vetting performed by the module 804 may be performed on a category by category basis, or other basis utilizing rules and generate or calculate a vetting result of the O/SME. The vetting result may be a single value or there may be multiple vetting results that are created to provide to different third party sources depending upon the type of vetting result that the third party source wants to use.

A present O/SME vetting data module 806 may be utilized to present an operator at the vetting organization with the ability to view and/or edit vetting information and results of the vetting that may be performed manually, semi-automatically, or automatically. The module 806 may produce a user interface, such as that shown in FIG. 6, that consolidates the vetting information that may have been collected by the module 802.

An established vetting rules module 808 may be configured to enable the vetting organization or service provider to establish vetting rules for use in vetting an O/SME. The vetting rules may include a variety of rules, such as order of priority, mathematical weighting of information identified in each vetting category, number and location of each vetting source (e.g., data repositories for finding background, publication, public, or any other data used in the vetting process), or otherwise. In one embodiment, the vetting rules may be defined by the vetting organization and a third party source may have the ability to prioritize or otherwise select rules that the third party source wants and does not want to use in the vetting process.

A vetting or rating engine 810 may be configured to use the results from the vet O/SME module 804 and generate one or more vetting results that may be used in providing to a third party source for determining (i) whether the O/SME is to be a service provider that the third party source is willing to present to its customers, (ii) whether the results are to be in a numerical, alphanumerical, or Boolean representation, and (iii) otherwise create a standard by which the results are generated and made available to third party sources. That is, the vetting organization may have all vetting produce a common vetting result using a common vetting procedure such that all third party sources and O/SMEs have the same information and vetting performed thereon. Furthermore, the vetting organization may have a vetting threshold criteria by which it determines that the O/SMEs meet to be determined as a vetted O/SME who meets the threshold criteria.

More specifically, and with further regard to FIG. 6, the rating engine 810 may be used to automatically or semi-automatically determine vetting scores for each of the vetting categories associated with O/SMEs.

In another embodiment, a representative O/SME rating engine incorporates factual data vis-à-vis the ten categories or items of FIG. 6 regarding acclaimed information and public databases, where the O/SME has:

1. published works, such as books/memoires, which may be any book or written publication, instructional, motivational, historical, or otherwise;

2. starred in or produced DVDs, CDs, apps, live and taped broadcast programs, and other informational, instructional, educational, or entertainment in digital mediums from established publishing and production entities;

3. received local, regional, national, and/or international media recognition an accolades;

4. received overwhelmingly positive peer-to-peer and/or public ratings;

5. has direct affiliations and endorsements from well-known personalities and (other) celebrities; earned an advanced professional degree or high ranking/distinction from an established professional organization (e.g., university);

6. received positive recognition from professional agencies and bodies including, but not limited to, professional skills associations and/or guilds, universities and respected teaching establishments, research organizations, medical facilities and teaching colleges, non-profit humanitarian groups, security organizations, police agencies, and military units;

7. has, in general, clean legal records with no significant past or pending legal disputes, or no pattern of disputes arising from the respective services;

8. secured proper professional liability insurance;

9. has the ability to deliver scalable quality services; and

10. has regional, national, or international franchise, affiliate or sponsorship programs, thereby demonstrating commercial success, reliability, and overall quality for products and services offered.

Other items, such as number of social media followers, social media contacts, social media friends, industry group affiliations, industry group board positions, and so forth, may be utilized in accordance with the principles of the present invention.

For item 1 of the above list (published works), the rating mechanism may be used for author ranking, such as the author ranking system of Amazon®. For example, an author ranked in the top 1-2000 authors may receive a rating score of 1.0 out of a possible 1.0; if the author may be ranked 2001-4000 a rating score of 0.8 may be applied; if the author may be ranked 4001-6000 a rating score of 0.6 may be applied; if the author may be ranked 6001-8000 a rating score of 0.4 may be applied; and if the author may be ranked 8001-10,000 a rating score of 0.2 may be applied. Finally, if an author were to be ranked 10,001-20,000 a rating score of 0.1 may be applied. Any other scale or ranking system, such as using different ranges of the author rankings, may be utilized in accordance with the principles of the present invention.

The same sliding scale credit rating mechanism for rating O/SMEs based on publishers may also be applied to DVDs or apps produced by the top production studios/companies based on a national or industry rating. Item 2 (starred in video media) ratings may use the same or similar rating mechanism as item 1.

As an extension to item 1 or as a completely separate item from items 1 and 2, a number of units sold item (not listed) may be used as another measure to determine quality of the O/SME. Under this item, if the O/SME has sold a minimum of 5,000 units but fewer than 10,000 units, the O/SME may receive a rating score of 0.1 out of a maximum rating of 1.0 (based on a minimum of 50,000 are units sold.) If 10,000-19,999 units are sold, the O/SME may receive a rating score of 0.2; 20,000-29,999 units sold may produce a score of 0.4; 30,000-39,999 units sold may produce a score of 0.6, 40,000-49,999 units sold may produce a rating score of 0.8, until a maximum score of 1.0 is achieved by selling in excess of 50,000 units. Notably, the baseline number of units to achieve a maximum rating score may change per the third party source or vetting organization's prerogative. It should be understood that the ranges may be varied based on the type of media (e.g., printed or electronic media, such as books, DVDs, CDs, apps, online downloads) on which the O/SME distributes his or her goods.

In an alternative embodiment, units sold may also be rounded up or down to the nearest thousand to accrue a one one-hundredth (0.01) of a rating point. For example, the rating points may be based on a number of units sold, such as a maximum of 50,000 units (or any other baseline number for a maximum score) sold (e.g., 7,000 units sold would represent a rating of 0.125 or 0.1+0.025 (based on 50,000/2,000). As another numerical example, if 14,000 units were sold, an additional 0.125 would be added to the standard 0.2 rating score for a total rating of 0.325. If 33,000 units were sold, an additional 0.167 would be added to the standard 0.6 credit for a total rating of 0.717 out a possible 1.0.

Notably, this rating scale for number of units sold may be helpful in specifically identifying O/SMEs who have successfully self-published books (including ebooks), CDs, DVDs, games, apps or otherwise, but who may not have achieved any rating credits pertaining to items 1 and 2.

Further regarding item 3 (local, regional, national and/or international accolades), a cumulative weighted rating may again be used If the O/SME received a local and/or regional award, a 0.1 credit may be awarded (up to maximum cumulative rating credit score of 0.5 (for five local awards); a national award 0.25 (weighted), and finally, an international award an additional 0.5 (weighted) credit. Other or alternative awards may be utilized in accordance with principles of the present invention. A 0.1 to 1.0 rating score for all awards received may be applied.

Regarding item 4 (peer-to-peer ratings), using the example of Amazon's star rating system, if the O/SME has received a 3 out of 5 star rating, the O/SME may receive a rating score of 0.6 out of a possible 1.0. If the O/SME has received a 4 out of 5 star rating, the O/SME may receive a 0.8 rating score out of a possible 1.0. If the O/SME has received a 5 out of 5 star rating, the O/SME may receive a maximum 1.0 rating score out of a possible 1.0. Services feedback by consumers may be examined by a vetting organization that, depending on the results, may reduce the O/SME's rating score or credits. Alternative rating scales may be utilized in accordance with the principals of the present invention.

Further regarding item 3 (local, regional, national and/or international press), a cumulative rating score may again be used. If the O/SME was featured in local and/or regional press more than a certain number of times, such as three times, the O/SME may receive an initial rating score of 0.25; if featured in national press and/or shows (e.g. Time Magazine, USA Today, Men's Fitness, NBC, ABC, CBS, FOX, etc.) or a regional publication or show with a large distribution (e.g. New York Times, Washington Post, Good Day NY, etc.) at least once, an additional 0.25 rating score may be accrued, and finally, if featured in international press or shows (Financial Times, Reuters, CNN, BBC, etc.) an additional 0.25 rating score may accrued. In total, the O/SME may establish a cumulative rating score of 0.25 to 1.0 for press articles and in person media appearances. Other forms of media outlets, such as online, which are determined to be credible and have a large enough audience may also utilized in accruing rating points.

Regarding item 5 (direct affiliations/endorsements with well-known personalities and celebrities), for each well-known personality/celebrity endorsement the O/SME may earn a certain rating score, such as 0.25. Using such a rating scale, four “celebrities” or more may earn a maximum cumulative rating of 1.0. Celebrities may be defined, for example, as someone in the public eye who has achieved a pre-determined level of success in his or her respective field. For example, a celebrity may be defined as a person who has had a role in a minimum of three separate mainstream studio or television productions, a role in a production which has continued for three seasons or more or had three major recording hits within the top one hundred most popular songs or albums or who may be a professional acclaimed athlete in a popular mainstream sport (National Football League, Major League Baseball, National Basketball Association, National Hockey League, Pro Tennis Circuit, Olympic Medalist, etc.)

Regarding item 6 (advanced professional degree or high ranking/distinction from an established professional organization), for a degree earned by the O/SME particular to a profession a rating of 0.20 may be applied. A degree earned with honors (cum laude), high honors (magna cum laude) or highest honors (summa cum laude) may add another 0.05 credit to the respective degree per each respective level of honors until a maximum credit of 1.0 is achieved. For instance, a B.A. or B.S.E. may earn 0.20 while a B.A. or B.S.E earned cum laude may earn 0.25, magna cum laude may earn 0.30, and summa cum laude, may earn 0.35. A master's degree in any field or a JD may earn an additional 0.25 and an MD or PhD may accrue an additional 0.50. Honors credits may add a 0.05 credit (similar to undergraduate degrees earned with honors, high honors, or highest honors). Therefore, JD degree earned with highest honors, may provide a credit of 0.40 (e.g., 0.025+0.05+0.05+0.05). In other words, an O/SME may earn from 0.20 to 1.0 rating score for cumulative professional degrees and bolstered by honors attached to the specific degree.

As another example, a rating credit score may also be applied for former and current military ranks: sergeant (0.1 rating), 1st sergeant (0.2 rating) master sergeant (0.3 rating), sergeant major (0.4 rating), lieutenant (0.5 rating), captain (0.6 rating), major (0.7 rating), lieutenant colonel (0.8 rating), colonel (0.9 rating) and all ranks of general (1.0 rating), respectively. Any individual citations may also add an additional 0.1 credit up to maximum additive credits of 1.0. The highest medal awards such as a Bronze Star (0.25 credit), Silver Star (0.50 credit), or Medal of Honor (1.0) would be weighted (similar to academic degrees with honors). A master's degree may add a weighted rank of 0.25 while a PhD might add a weighted rank of 0.5 towards a maximum allowance of 1.

A rating credit score may also be applied for former and current police ranks: officer/corporal/deputy (0.1 rating), detective (0.2), sergeant (0.3 rating) lieutenant (0.4 rating), captain (0.5 rating), major (0.6 rating), deputy chief (0.7 rating), chief/sheriff (0.8 rating), colonel/commissioner/director (0.9 rating) respectively. Any individual citations or medals may also add an additional 0.1 credit up to maximum additive credits of 1.0. A Masters Degree or Juris Doctor may add a weighted rank of 0.25 while a PhD might add a weighted rank of 0.5 towards a maximum allowance of 1.0 rating.

For Government Service (GS) ratings the following rating credit scores may be applied: 7 (0.1 rating), 9 (0.2 rating), 11 (0.3 rating), 12 (0.4 rating), 13 (0.5 rating), 14 (0.6 rating), 15 (0.7 rating) and “supergrades” Schedule A (0.8 rating), B (0.9 rating), and C (1.0 rating) respectively. A Masters Degree or Juris Doctor may add a weighted rank of 0.25 while a PhD might add a weighted rank of 0.5 towards a maximum allowance of 1.0 rating.

For martial arts, yoga, fitness trainers, etc., a rating credit score may also be created using the expert level as a baseline and awarded additional credits for advanced expert levels specific to discipline or specialty. An example may be a first-degree blackbelt awarded by a popular accredited organization that may earn an 0.5 weighted rating while additional blackbelt degrees may merit 0.1 rating scores until a maximum rating of 1.0 is achieved. An example may be a third degree blackbelt who may achieve a rating of 0.7 (first degree blackbelt (weighted) 0.5+second degree 0.1+third degree 0.1=0.7) out of 1.0. An A.B. or B.S.E degree may add a 0.25, a Masters Degree or Juris Doctor may add an additional weighted rank of 0.25, while a PhD may add a weighted rank of 0.5 towards a maximum allowance of 1.0 rating.

Continuing with item 6, (recognition from non-profit professional agencies and bodies including, but not limited, to professional skills associations and/or guilds, universities and respected teaching establishments, research organizations, medical facilities and teaching colleges, non-profit humanitarian groups, security organizations, police agencies, and military units), an O/SME may earn a rating score of 0.1 for an award/commendation from a local organization, 0.25 for each award/commendation from a state or national organization/agency. An accumulation of awards/commendations may earn up to a maximum 1.0 rating.

Regarding item 7 (legal records history), the presumption is that a pre-qualified O/SME has a generally clean legal record or is free from significant judgments rendered. Therefore, the O/SME may begin with a maximum credit rating of 1.0. However, if the O/SME was sued and found liable, the O/SME may earn a negative rating of -0.1 for each negative judgment including insurance claim settlements benefitting clients. If there were any pending litigation at the time of the rating, a negative -0.1 is assigned to the O/SME. In other words, the O/SME is provided a maximum credit rating of 1.0, which is his or hers to lose depending on litigation history.

Regarding item 8 (secured proper professional liability insurance), a rating score may be determined based on type of liability insurance, provider of liability insurance, amount of liability insurance, and so forth. The ratings may range from 0.0 for no liability insurance to 1.0 for liability insurance that covers an O/SME directly with regard to services being provided, maximum liability coverage, and with a top tier insurance carrier.

Regarding item 9 (ability to deliver scalable quality services), a rating score may be determined based on the services and scalability of those services being offered by the O/SME. Scalability refers to a number of service providers from an O/SME can be used to deliver services, number of locations of services, and so forth. Scalability may also include range of services (e.g., limited to children versus services that can satisfy children, adults, and seniors). It should be understood that the scalability of services may be defined in a variety of ways, and that rating scores may reflect the various service scalability offerings of which the O/SME can deliver to customers.

Regarding item 10 (local, regional, national, or international franchise, affiliate or sponsorship programs), if the O/SME has numerous programs or locations, a rating may be determined based on the footprint or diversity of the program. As an example, a rating 0.1 may be assigned for each additional location/affiliate offering the O/SME's services up to a 1.0 credit. In other words, if the O/SME has ten separate programs or locations, each 0.1 credit is additive for a maximum credit of 1.0. Alternatively, if the program is local, a rating of 0.1 may be applied (e.g. single town or city or single state 0.1); multi-state a 0.3; a single region including more than one state or a combination of specific contiguous states a 0.5; national locations a 0.75 and international locations a maximum of 1.0). Other factors may include number of years in business, number of years at a particular company, number of years in a certain corporate position above a certain level of management (e.g., CEO, CFO, CIO, regional manager, national manager, production manager, vice president, etc.), and so forth.

The vetting process may be performed on a continuous, periodic (e.g. quarterly) or non-periodic basis (e.g. responsive to an event, such as a new product or service release). The vetting process may access product and/or services reviews of customers regarding the products an/or services being provided by the O/SME, investigate the claims, and issued a weighted factor based on the finds of the claims. Customer claims may be authenticated using artificial intelligence methods. Notably, these guidelines are flexible and some questions/vettable attributes may be more heavily weighted than others in determining the O/SME's score. Any further virtues, commercial appeal, or other unique qualities based on, but not exclusive, to the aforementioned criteria or any other criteria distinguishing the products and services of an O/SME may also be sourced by a vetting/scoring engine or presented by an O/SME directly to the vetting engine who wishes join the vetted network or, if an accepted member, to improve the O/SME's rating or gain acceptance.

In addition, the principals of the present invention's envisioned vetting process may be conducted using alternative formats and venues. Broadly, the principles of the present invention may be thought of as ascertaining and aggregating verifiable facts, objective professional opinions, and qualified peer-to-peer reviews pertaining to a selected O/SME. A combination of these findings may be used in a rating/vetting scale or artificial intelligence model that determines the value/quality of services and goods offered by that specific O/SME. The vetting process may be manual, semi-automatic, automatic, or a combination thereof depending on the source of the vetting information (i.e., some sources may be machine readable and searchable while others may not). In one embodiment, a vetting organization computing system may be configured to perform searches to gather vetting information, and automatically rate that gathered vetting information, as illustrated above. In cases where the vetting information cannot be automatically gathered and rated, a semi-automatic process, such as using a web crawler or other search tool, may be utilized to gather the information to enable a user to extract vetting information for a rating engine to rate the extracted vetting information. In cases where the information cannot be easily extracted, a manual process may be used and ratings established by an operator or rating professional may be entered into a user interface. Other configurations that perform similar functions in accordance with the principles of the present invention are also contemplated.

A manage vetting results module 812 may be configured to store the vetting results of the O/SMEs and enable third party sources to access or otherwise receive the O/SME vetting results. The module 812 may be configured to provide a dynamic lookup of the vetting results. Alternatively, the module 812 may be configured to periodically communicate updates of vetting results of O/SMEs to third party sources who have requested such updates or have previously requested vetting results. In one embodiment, the module 812 may be configured to send out vetting results to third party sources in the event that the vetting results have a significant change (e.g., change from a passing result to a failing result as a result of criminal activity or financial shortcomings occurring with the O/SME). In one embodiment, the module 812 may be configured to issue or provide a seal of approval by the vetting organization to third party sources for posting in association with any content or information associated with an O/SME so that customers of the third party source may know that the vetting organization has vetted the O/SME for providing services to customers of the third party source.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed:

1. A system for offering vetted services of an originator/subject matter expert (O/SME) by a third party source of products and services of multiple O/SMEs, said system comprising:
a content data repository configured to store data associated with the O/SME, the data inconclusive of product or service content representative of products or services being offered by the O/SME; and
a processing unit in communication with said data repository, and configured to:
collect, from said data repository, select data associated with the O/SME;
query an O/SME vetted data repository configured to store vetting data representative of vetting results of the O/SME; and
in response to receiving vetting data indicative of the O/SME having a vetting score at or above a passing vetting threshold value,
enabling an interactive booking feature to be displayed in relation to the select data associated with the O/SME and activated to enable a user to book services with the O/SME,
otherwise, not enabling the interactive booking feature to be displayed and activated.

2. The system according to claim 1, wherein said processing unit, in querying the vetting data repository, is configured to dynamically query the vetting service data repository in response to the user selectively requesting to view the select data associated with the O/SME.

3. The system according to claim 1, wherein said processing unit, in querying the vetting data repository, is further configured to communicate the passing vetting threshold value.

4. The system according to claim 1, wherein said processing unit, in querying the O/SME vetted data repository, is further configured to periodically query the O/SME vetted data repository and, responsive to receiving the vetting data associated with the O/SME, store the vetting data in said data repository, thereby enabling said data repository to determine whether or not to enable the interactive booking features without having to dynamically access the vetting service data repository.

5. The system according to claim 1, wherein said processing unit is further configured to:
receive a request by the user via the interactive booking feature;
in response to receiving the request, cause a booking display to be presented to the user; and
enable the user to book services with the O/SME via the booking display.

6. The system according to claim 5, wherein said processing unit, in enabling the user to book services with the O/SME, is further configured to collecting payment from the user.

7. The system according to claim 6, wherein said processing unit is further configured to apportion a first amount of the collecting payment to the O/SME and a second amount of the collected payment to the third party source.

8. A method for offering vetted services of an originator/subject matter expert (O/SME) by a third party source of products and services of multiple O/SMEs, said method comprising:
storing, in a content data repository, data associated with the O/SME, the data inconclusive of product or service content representative of products or services being offered by the O/SME;
collecting, by a processing unit from the data repository, select data associated with the O/SME;
querying an O/SME vetted data repository configured to store vetting data representative of vetting results of the O/SME; and
in response to receiving vetting data indicative of the O/SME having a vetting score at or above a passing vetting threshold value,
enabling an interactive booking feature to be displayed in relation to the select data associated with the O/SME and activated to enable a user to book services with the O/SME,
otherwise, not enabling the interactive booking features to be displayed and activated.

9. The method according to claim 8, wherein querying the vetting data repository includes dynamically querying the vetting service data repository in response to the user selectively requesting to view the select data associated with the O/SME.

10. The method according to claim 8, wherein querying the vetting data repository includes communicating the passing vetting threshold value.

11. The method according to claim 8, wherein querying the O/SME vetted data repository includes periodically querying the O/SME vetted data repository and, responsive to receiving the vetting data associated with the O/SME, storing the vetting data in the data repository, thereby enabling the data repository to determine whether, or not to enable the interactive booking features without having to dynamically access the vetting service data repository.

12. The method according to claim 8, further comprising:
receiving a request by the user via the interactive booking feature;
in response to receiving the request, causing a booking display to be presented to the user; and
enabling the user to book services with the O/SME via the booking display.

13. The method according to claim 12, wherein enabling the user to book services with the O/SME, includes collecting payment from the user.

14. The method according to claim 13, further comprising apportioning a first amount of the collecting payment to the O/SME and a second amount of the collected payment to the third party source.

15. A method of vetting an originator/subject matter expert (O/SME), said method comprising:
collecting, by a processing unit, vetting data associated with the O/SME from a plurality of data sources;
establishing rules for vetting the O/SME;
generating, by the processing unit, a vetting result based on the collected vetting data and established rules;
storing, by the processing unit, the vetting result in a data repository; and
responsive to receiving a query, by the processing unit from a third party source via a communications network, communicating the vetting result to the third party source.

16. The method according to claim 15, further comprising generating, by the processing unit, a user interface configured to enable a vetting reviewer to selectively review the vetting data collected from multiple vetting sources;
displaying, by the processing unit, the vetting data for the vetting reviewer to selectively review;
determining a vetting score for each of the vetting data available for review from the vetting reviewer via the user interface; and
determining, by the processing unit, the vetting result based on the vetting scores.

17. The method according to claim 16, wherein receiving a query includes receiving a query inclusive of a vetted threshold value; and
wherein determining the vetting result uses the vetted threshold value to determine whether the vetting result is a pass or fail result.

18. The method according to claim 16, further comprising calculating at least one statistic based on the collected vetting scores, wherein determining the vetting result includes calculating the vetting result based on the at least one statistic.

19. The method according to claim 15, further comprising communicating data representative of a vetted seal to cause the third party source to display the vetted seal in association with O/SME data being displayed.

20. A system for vetting an originator/subject matter expert (O/SME), said system comprising:
a data repository configured to store vetting data associated with the O/SME;
a processing unit in communication with said data repository, and configured to:
collect the vetting data from a plurality of data sources via a communications network;
generate a vetting result based on the collected vetting data and rules established for vetting the O/SME;
store the vetting result in said data repository; and
responsive to receiving a query from a third party source via the communications network, communicate the vetting result to the third party source.

21. The system according to claim 20, wherein said processing unit is further configured to:
generate a user interface to enable a vetting reviewer to selectively review the vetting data collected from multiple vetting sources;
display the vetting data for the vetting reviewer to selectively review;
determine a vetting score for each of the vetting data available for review from the vetting reviewer via the user interface; and
determine the vetting result based on the vetting scores.

22. The system according to claim 21, wherein said processing unit, in receiving a query, is further configured to receive a query with a vetted threshold value; and
wherein determining the vetting result is further configured to use the vetted threshold value to determine whether the vetting result is a pass or fail result.

23. The system according to claim 21, wherein said processing unit is further configured to calculate at least one statistic based on the collected vetting scores, and wherein said processing unit, in determining the vetting result, is further configured to calculate the vetting result based on the at least one statistic.

24. The system according to claim 20, wherein said processing unit is further configured to communicate data representative of a vetted seal to cause the third party source to display the vetted seal in association with O/SME data being displayed.
